(19) United States
(12) Patent Application Publication
(10) Pub. No.: US 2018/0268090 A1
(43) Pub. Date: Sep. 20, 2018

(54) METHODS AND SYSTEMS FOR PARAMETRIC ASSET PERFORMANCE MODELING

(71) Applicant: General Electric Company, Schenectady, NY (US)

(72) Inventors: Liling REN, Niskayuna, NY (US); Eric Richard WESTERVELT, Niskayuna, NY (US); Mark Lawrence DARNELL, Grand Rapids, MI (US); David LAX, Grand Rapids, MI (US); Szabolcs BORGYOS, Grand Rapids, MI (US); Russell RAMAKER, Grand Rapids, MI (US); James LOPEZ, Niskayuna, NY (US)

(21) Appl. No.: 15/462,343

(22) Filed: Mar. 17, 2017

(51) Int. Cl. G06F 17/50; G06F 17/11

(52) U.S. Cl. CPC G06F 17/5009; G06F 2217/16; G06F 17/11

(57) ABSTRACT

A system, computer-readable medium, and a method including determining a reference baseline model that accurately represents a behavior of a nominal or average asset of a particular type; determining a parametric model that accurately represents a deviation between a performance of a specific asset and the reference baseline model, the specific asset being of the particular type; tuning the parametric model based on operational data from the specific asset; combining the reference baseline model and the parametric model to obtain a parametric performance model for the specific asset; and storing a record of the parametric performance model for the specific asset.

### BACKGROUND

The field of the present disclosure relates generally to aircraft models, more particularly, to systems, devices and methods of tuning and deploying aircraft asset models for operation for a specific aircraft asset.

Traditional models intended to represent the characteristics and behaviors of an aircraft are generally static and rarely reflect true, accurate, or even up to date characteristics of a specific aircraft asset. These shortcomings may be mainly attributable to manufacturing tolerances and performance deteriorations that develop over time. Such model inaccuracies might lead to inaccurate planning and control actions with respect to business and operational objectives of a particular aircraft. Additionally, these types of model inaccuracies might also lead to unreliable monitoring of the aircraft.

Model inaccuracies may result in obscuring an ability for an entity to understand operational conditions of the aircraft and its associated systems. For example, an inaccurate model may lead to difficulties in understanding why a specific engine of the aircraft is operated in a particular manner. It might also result in hidden inefficiencies and waste. For example, a flight operational procedure used in an effort to save fuel may actually cause a fuel burn higher than the true optimal fuel burn and/or adversely impact engine life due to an inaccurate model relied on in planning and executing the intended procedure.

Therefore, there exists a need for methods and systems that improve aircraft modelling, which can support optimized planning and operational control for a specific aircraft asset.

### BRIEF DESCRIPTION

In one aspect, an embodiment of the present disclosure relates to determining a reference baseline model that accurately represents a behavior of a nominal or average asset of a particular type; determining a parametric model that accurately represents a deviation between a performance of a specific asset and the reference baseline model, the specific asset being of the particular type; tuning the parametric model based on operational data from the specific asset; combining the reference baseline model and the parametric model to obtain a parametric performance model for the specific asset; and storing a record of the parametric performance model for the specific asset.

In other embodiments, a system may implement, execute, or embody at least some of the features of the processes herein. In yet another example embodiment, a tangible medium may embody executable instructions that can be executed by a processor-enabled device or system to implement at least some aspects of the processes of the present disclosure.

### DRAWINGS

These and other features, aspects, and advantages of the present disclosure will become better understood when the following detailed description is read with reference to the accompanying drawings in which like characters represent like parts throughout the drawings, wherein:

FIG. 1 is an illustrative graph depicting an example impact of model inaccuracy on one type of aircraft asset operational optimization;

FIG. 2 is an illustrative example of some aspects of a parametric modeling process or framework, according to some aspects herein;

FIGS. 3-10 each illustrate an example of aerodynamic performance characteristics that may be modeled for a specific aircraft asset, according to some embodiments herein;

FIG. 11 is an illustrative depiction of a process, in accordance with some embodiments herein;

FIG. 12 is an illustrative example of a model prediction process, according to some aspects herein; and

FIG. 13 is an illustrative depiction of a block diagram of a system or device that can support some processes disclosed herein.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

The present disclosure, in general, relates to a framework and process of parametric performance modeling. The parametric performance modeling framework disclosed herein will be discussed, in large part, using a number of embodiments and contexts of use related to an accurate modeling and optimization of an aircraft asset for a variety of operational conditions. However, the various use-cases, embodiments, and operational contexts discussed herein are examples and not limitations of the parametric performance modeling framework.

The assignee hereof, General Electric Company, has developed an integrated aircraft system level digital model of flight operational characteristics referred to as Aircraft Digital Twin (ACDT). The ACDT system includes, but is not limited to, the flight performance at given flight conditions and a four-dimensional (4D) flight trajectory for a particular aircraft asset. To address the issue of model accuracy for a specific aircraft asset (i.e., a particular tail number), a parametric modeling approach has been developed to allow tuning of the model using previously recorded and/or streamed data from real world flight operations from the particular tail number. In some aspects, the ACDT leverages an accurate model of the engine(s) (e.g., Engine Digital Twin) installed on the specific aircraft asset (also referred to herein simply as the aircraft) for engine performance model parameters. The ACDT also leverages the flight analytics capabilities with data recorded from the aircraft for model parameter tuning. In some aspects, the ACDT can then be deployed in one or more contexts to allow for tail number specific planning, tail specific control optimization, and reliable monitoring. In some instances, the processes and methods of the present disclosure may be used to better understand system operational conditions, as well as to recover otherwise hidden inefficiencies and flight operations waste attributable to model inaccuracies.

As referred to herein, an aircraft asset may also be referred to as a tail number since aircraft operators often identify their aircraft assets by their tail number and, in some instances herein, simply as an aircraft. An aircraft asset may be defined by its configuration (i.e., asset configuration) and status (i.e., asset status). The asset configuration may include the specific airframe, specific engine(s) installed, external stores or modifications, and control systems that may influence the flight performance of the specific aircraft. The system status may include performance deterioration, damages, temporary repairs or modifications, or temporary limitations to the system performance of the specific aircraft.

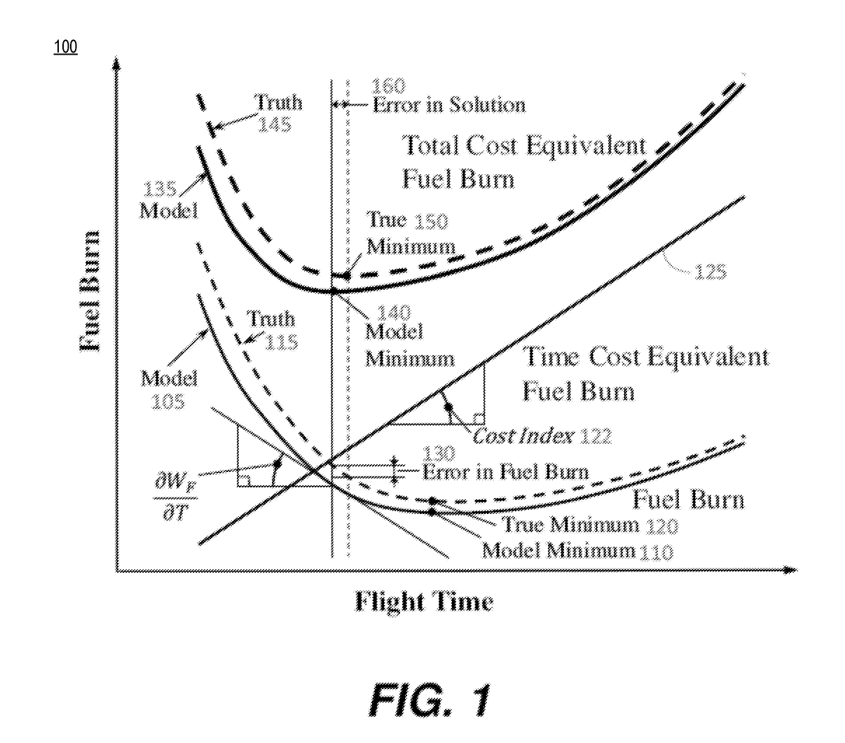

Referring to FIG. 1, an illustrative graph 100 depicting an example impact of model inaccuracy on one type of aircraft asset operational optimization is shown. In some aspects, FIG. 1 demonstrates some reasons and motivations for some of the concepts and embodiments of the present disclosure. In particular, graph 100 illustrates the impact of model accuracy on operating cost optimization, including fuel and time costs. Curve 105 represents the fuel burn (y-axis) for an aircraft relative to a flight time (x-axis). The minimum fuel burn for the aircraft asset is shown at 110. If an aircraft asset were to fly a flight segment in the specific time indicated at 110, then the aircraft asset would burn the minimum amount of fuel. It is noted that curve 105 ignores the cost of time that may include costs associated with a flight crew's time, a passenger cabin crew's time, maintenance cost associated with flight time, etc. In some contexts, a cost index (CI) 122 is used to represent a time cost equivalent in terms of fuel burn. In FIG. 1, the time cost equivalent fuel burn is represented by straight line graph 125.

The fuel burn 105 plus the time cost equivalent fuel burn 125 is represented by the total cost equivalent fuel burn curve at 135. The minimum total cost equivalent fuel burn for curve 135 is located at 140. However, if the models 105 and 135 include errors, as indicated by dashed line curves 115 and 145 representing the true fuel burn and the true total cost equivalent fuel burn for the aircraft respectively, then there will be a shift or change in the optimal (e.g., minimum fuel burn or minimum total cost equivalent fuel burn) data point. The difference between the initial model curves and the actual (i.e., true) data curves represents a deviation or error. For the true fuel burn curve 115, the horizontal shift of the minimum point (from 110 to 120) may be relatively small. Yet, when the fuel burn change is added to the time cost, then the horizontal shift is more significant as seen by the model minimum 140 on the model curve 135 and the true minimum 150 on the true curve 145 of the total cost equivalent fuel burn. The horizontal shift 160 represents the error in the optimization solution. If this error 160 is not accounted for, the actual fuel burn will have an increase 130 measuring the difference on the true fuel burn curve 115. The change seen is not only due to actually operating the aircraft with a different fuel burn rate but also operating at the wrong supposed optimal (i.e., minimum cost) flight time or speed. That is, the deviation between curves 135 and 145 indicates the (in)accuracy of the model but also the impact of the model's (in)accuracy on the optimization.

In some embodiments regarding a profile optimization, an aircraft model may be provided by the airframer, where the model is provided for a nominal or average aircraft of a particular type. Although not necessarily accurate for a specific tail number at a given time during its life, such a model is generally characterized by high fidelity and captures the general behavior of the aircraft performance reasonably quite well. Assuming that such a baseline model exists, whether provided directly by the airframer or otherwise proved to be of similar quality, a parameterization of an aircraft asset of the same particular type as the model might seek to model deviations of a subset of key performance characteristics of the specific aircraft asset relative to such a baseline model.

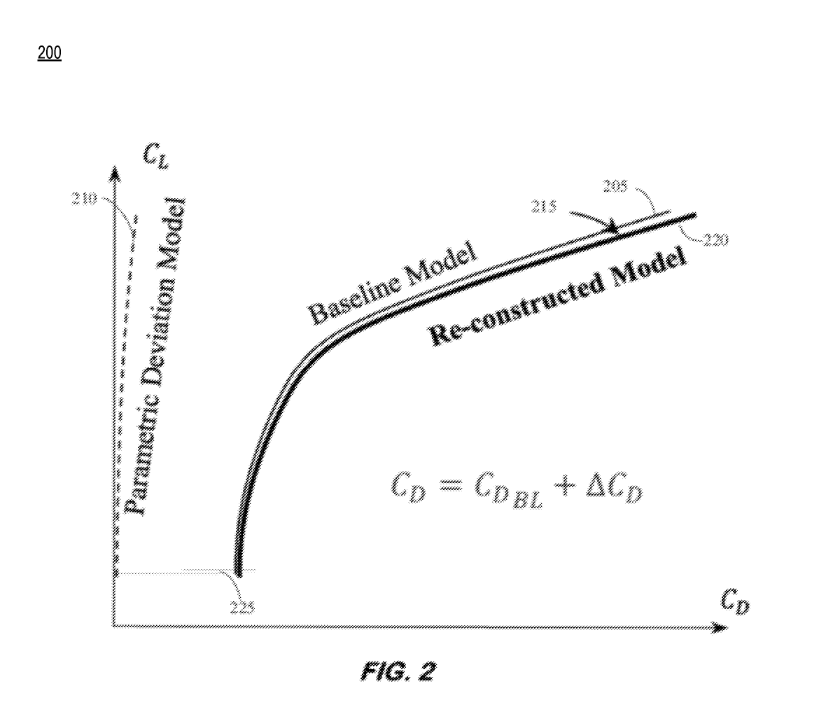

In some regards, a general concept of this approach is illustrated by an example of the drag polar performance characteristic of a specific aircraft as illustrated in FIG. 2. The approach illustrated in the example of FIG. 2 is different from the practice of using a single percentage factor to represent deviations for the entire range of operating conditions. Rather, the approach depicted in FIG. 2 is a physics-based approach to capture the per tail (i.e., specific aircraft asset) deviation in response to various operating conditions. Accordingly, in some aspects the concepts depicted in FIG. 2 can leverage baseline models that are known or that can be generated.

Referring to FIG. 2, a baseline model for an operational performance characteristic of an aircraft is represented by curve 205. This curve is reflective of an average or nominal performance of the aircraft, as opposed to a specific aircraft. However, given a desire to, for example, operate and monitor an aircraft in an optimal manner to manage a direct operating cost (DOC), the baseline model curve is insufficient to completely and accurately represent a performance of the asset since it does not adequately capture the true performance of a specific aircraft.

In the example of FIG. 2, the performance characteristic of drag is represented. Other performance characteristics can be modeled. In some embodiments, the one or more performance characteristics that impact a performance of the asset being modeled for the various and relevant operational conditions of the asset might be selected for modeling. Regarding the performance of a specific aircraft asset, key performance characteristics related to, for example, drag and lift may be selected and modeled in some embodiments.

Regarding an actual performance of the specific aircraft, actual real world data from the specific aircraft operations can be recorded and used to determine a parametric deviation model 210. Parametric deviation model 210 can be determined based on the physics (e.g., relationships of motion and behavior in space and time, and more specifically aerodynamics laws) governing the specific aircraft as it operates in the given operational conditions. The parametric deviation model 210 accurately represents a deviation (i.e., difference) between a performance of the specific aircraft and the reference baseline model curve 205. By further combining the reference baseline model and parametric deviation curve 210, an accurate representation of the specific aircraft's performance can be obtained and represented by re-constructed model curve 220. As shown, there is a deviation or difference 215 between the reference baseline model curve 205 and the re-constructed parametric performance curve 220. The physical meaning of the difference 215 may include a vertical shift 225, a horizontal shift, and a change in shape of the drag polar.

In the example of FIG. 2, the drag coefficient is represented by the x-axis and the lift coefficient (CL) is represented by the y-axis of graph 200. The coefficients of drag (CD) for the specific aircraft asset (C_{D}) is equal to the coefficients of drag for the baseline model (C_{D}_{_{BL}}) plus the deviation from the coefficients of drag for the baseline reference model (ΔC_{D}). Accordingly, C_{D}=C_{D}_{_{BL}}+ΔC_{D}.

In some embodiments, baseline models might potentially be implemented within a flight management system (FMS) of an aircraft or any other high fidelity performance models external to the FMS models. It may be assumed that efforts are taken to verify the consistency of the behavior of the baseline models. Parameter tuning results against different baseline models may be compared to verify the effectiveness of the parameterization and the modeling approach.

In some embodiments, a subset of key performance characteristics for the specific asset being modeled are selected from one or more performance characteristics. The overall set of performance characteristics may be tailored to the particular type of asset under consideration. For example, the set of characteristics may include the performance characteristics relevant (i.e., impactful) to the operation of turbine fans, engine generators, aircraft, etc.

Regarding the example of an aircraft asset, some of the performance characterizes can include, as examples and not limitations, design parameters of the aircraft. The design parameters may be related to a gross weight and center of gravity (CG) characteristics of the aircraft and might include the aerodynamic performance characteristics of lift and drag, and corrections to lift and drag. A listing of some performance characteristics for an aircraft are shown in Table 1 below.

TABLE 1

| | | Example |
|---|---|---|
| Item | Description | Range |
| Lift Curve | CL as a function of angle of attack (AOA). For low | N/A |
| | speed, it is given in clean, and various flap and | |
| | landing gear configurations. For high speed, it is | |
| | given in clean configuration at different Mach. | |
| CG | Correction to CL due to pitch balance caused by | ~−2% for a |
| Correction | a CG shift. A forward CG will cause CL to | 10% CG shift |
| to Lift | decrease for the same AOA. | forward. |
| Thrust | Effect of thrust induced lift. It is strongest when | ~−3% when |
| Correction | flaps are extended, which deflects the engine jet | flaps are fully |
| to Lift | flow. Relative to level flight thrust, descent thrust | extended with |
| | will show a decrease in CL. | gear down. |
| Drag | CD as a function of CL. For low speed, it is given | N/A |
| Polar | in clean, and various flap and landing gear | |
| | configurations. For high speed, it is in clean | |
| | configuration at different Mach numbers. | |
| CG | CG corrections to the drag polar, due to pitch | ~−1% |
| Correction | balance. In the clean configuration, a forward CG | for a 10% |
| to Drag | will cause CD to increase for the same CL that is | CG shift |
| | in the normal range. | forward |
| Reynolds | Effect of Reynolds number differences, caused | ~±2% |
| Number | by altitude differences and deviation from | |
| Correction | standard temperature (DISA), from a nominal | |
| to CD | reference Reynolds number. | |

In some aspects, performance characteristics of the engine(s) installed on a specific aircraft are also considered in the modeling of the performance of the specific aircraft, in an effort to fully and accurately capture the aircraft's actual configuration (i.e., airframe and engines). Table 2 below includes a listing of some engine performance characteristics, though not intended to be exhaustive or limiting herein.

TABLE 2

| | | Example |
|---|---|---|
| Item | Description | Range |
| Maximum | Maximum net thrust or thrust setting | N/A |
| Takeoff | parameter (TSP) such as N1 for use | |
| Thrust | only during takeoff, as a function of | |
| | Mach, altitude, and DISA. | |
| Maximum | Maximum net thrust or TSP for use | N/A |
| Climb | during normal climb or step-climb, as a | |
| Thrust | function of Mach, altitude, and DISA. | |
| Maximum | Upper threshold of net thrust or TSP for | N/A |
| Cruise | normal cruise, as a function of Mach | |
| Thrust | number, altitude, and DISA. | |
| Bleed | Corrections to the above three | Up to 5% N1 |
| Corrections | maximum thrusts due to air bleed, either | reduction |
| to | given as separate ratings or as | |
| Maximum | deviation from the nominal ratings. | |
| Thrust | | |
| Generalized | Relationship between net thrust and | N/A |
| Thrust | TSP. | |
| Curve | | |
| Minimum | Idle thrust and idle fuel flow, given as | Negative |
| Idle Thrust | functions of Mach number and altitude. | thrust at high |
| and Fuel | | Mach |
| Flow | | |
| Fuel Flow | Either as a function of net thrust/delta, | N/A |
| | Mach number, and altitude with | |
| | corrections for DISA, or as a function of | |
| | TSP, Mach number, with an altitude | |
| | correction. | |
| Bleed | Corrections to corrected fuel flow due to | Up to 5% |
| Corrections | air bleed. If fuel flow has been provided | increase |
| to Fuel | for different bleed settings, then no | during normal |
| Flow | separate corrections are needed. | cruise |

In some embodiments, some criteria for selecting the performance characteristics to be parameterized can include those that reflect steady state performance rather than transient performance, normalized characteristics instead of absolute values, and deviations that significantly impact fuel cost. The normalized characteristics such as CL and CD might provide better insights into the model than absolute values of lift and drag. The latter are functions of many exogenous factors. Using normalized characteristics also means that the effective sample pool will be increased for the same set of raw sample data points. For example, for the same Mach number, data points at different altitudes or different aircraft weigh values will fall on the same drag polar. The Performance characteristics whose deviations do not significantly impact fuel cost may be selectively not considered in some embodiments. In some aspects, those parameters are assumed as being handled by the baseline model. For example, Reynolds number corrections to CD could be as high as ±2%, which is considered significant. However, this correction is mainly a function of operating conditions. The effect of performance deviations from one tail number to another on Reynolds number corrections will likely be a secondary effect, leading to an even smaller additional correction. Therefore, as long as the Reynolds number correction is properly handled by the baseline model, it does not necessarily have to be considered in the parameterization.

Model parameterization may be carried out at three different levels: 1) a low-level parameterization that seeks to model every single performance characteristic directly and separately, 2) a high-level parameterization that seeks to model a very few final cost metrics, and 3) a mid-level parameterization that seeks model deviations of a subset of key performance characteristics, all relative to a baseline model, assuming such baseline model exists. In some embodiments, a mid-level parameterization may be used since it might provide increased insights into the model. This level of parameterization, as compared to a high level or low level of same, increases the effective sample pool for the same set of raw sample data points during flight data based model tuning. Including the high fidelity baseline model, the granularity of the high fidelity model is preserved. That is, the mid-level parameterization may be a favorable choice to improve the accuracy of a high fidelity baseline model that is already in place. In some aspects, one or more techniques that can be used by the low-level parameterization are leveraged in deriving the mid-level parameterization and complexities and resources needed for a high level parameterization can be avoided.

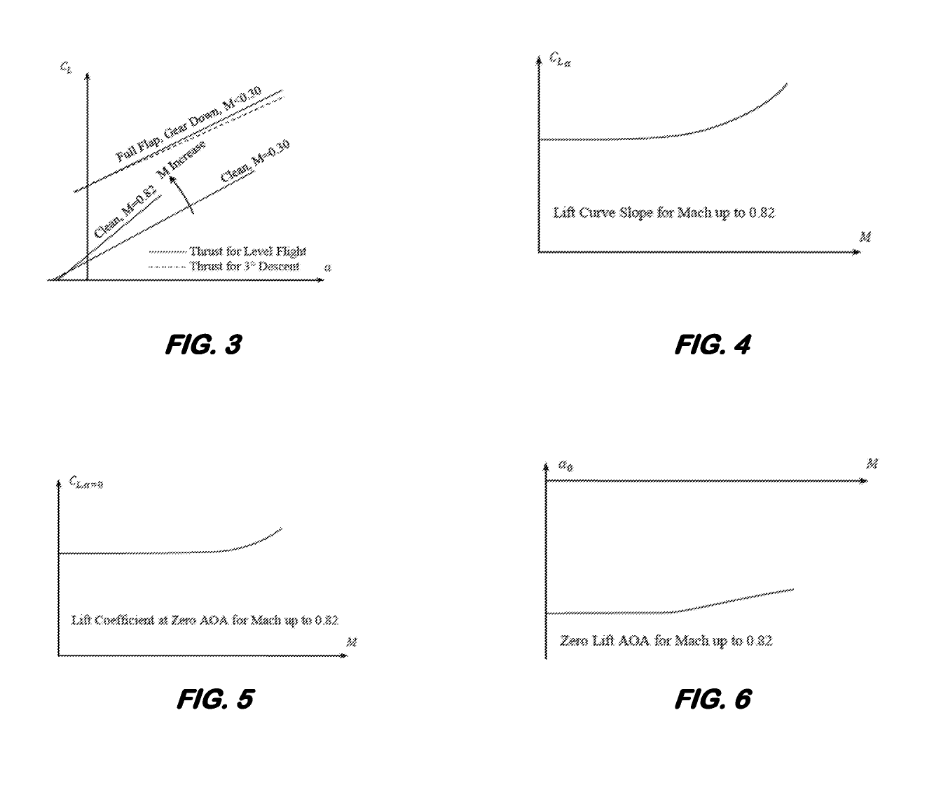

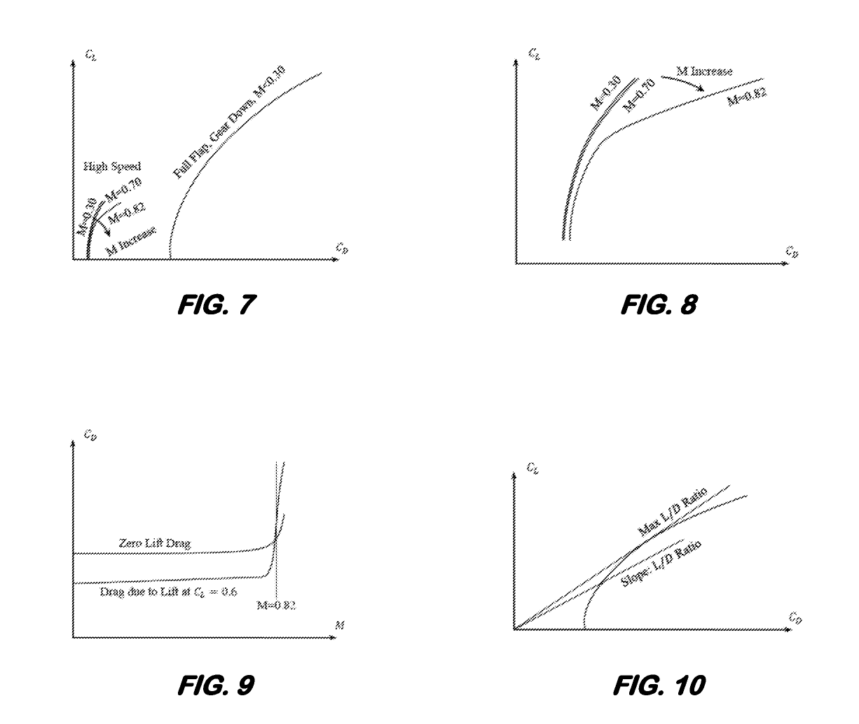

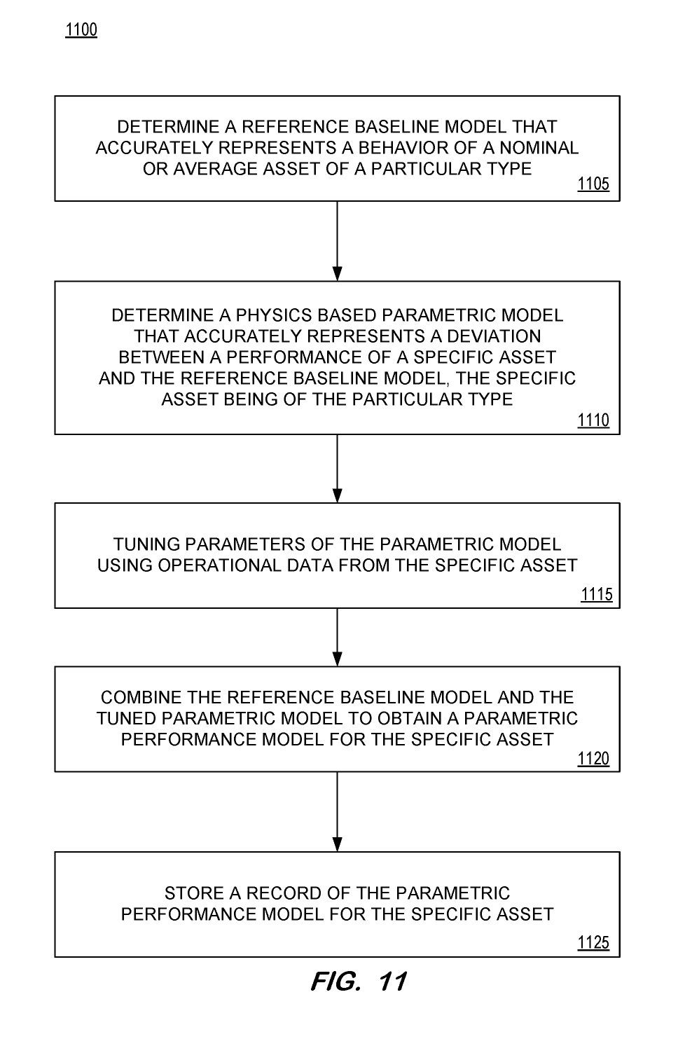

FIGS. 3-10 each illustrate an example of aerodynamic performance characteristics that may be modeled for a specific aircraft asset, according to some embodiments herein. For example, FIG. 3 includes lift curves for different Mach numbers and for different thrusts of an aircraft, FIG. 4 illustrates a lift curve slope for an aircraft as Mach number increases, FIG. 5 includes a curve illustrating the lift coefficient at zero AOA (angle of attack) for an aircraft as Mach number increases, and FIG. 6 includes a curve illustrating zero lift AOA for certain Mach conditions for an aircraft. FIG. 7 includes curves illustrating both low speed and high speed drag polars for an aircraft at different Mach numbers, FIG. 8 includes curves illustrating high speed drag polars for an aircraft at different Mach numbers, FIG. 9 includes curves illustrating drag due to lift for an aircraft as Mach numbers, and FIG. 10 depicts curves illustrating lift/drag ratio for an aircraft. The aerodynamic performance characteristics illustrated by FIGS. 3-10 may be viewed as a graphical representation of a baseline model. As illustrated by these figures, some aerodynamic performance characteristics are highly nonlinear and they might not be easily expressed in analytical form. This is generally true for performance characteristics of many different types of physical assets including, for example, aircraft, engines, locomotives, wind turbines, etc. Thus, a baseline model may be expressed in the numerical form as lookup tables or data graphs. Sometimes, a baseline model may be provided in an analytical form as theoretical formulas, empirical formulas, or a combination of theoretical and empirical formulas as functions of operating conditions, such as, for example, pressure, temperature, Mach number, etc.

Regarding FIGS. 3-10, additional, fewer, and alternative performance characteristics may be considered other than those depicted in these examples and used in conjunction with some embodiments herein.

FIG. 11 is an illustrative flow diagram of one example embodiment of a process 1100, in accordance with some embodiments herein. Process 1100 may be executed by a system, an apparatus, and combinations thereof, including a system, onboard a specific aircraft, an off-board system (e.g., a ground based system, a satellite based system, a cloud based service, etc.), and combinations thereof. In one embodiment, a flight management system located entirely onboard an aircraft or distributed across computing systems and networks including a combination of onboard, satellite, and ground systems that might be coupled to a distributed database may include implementations of process 1100. In some instances, a system or device having a processor may execute program instructions of, for example, an application or an “app” embodied as a tangible medium to effectuate the operations of process 1100. In some embodiments, at least a portion of process 1100 may be implemented by software components deployed as software as a service.

At operation 1105, a reference baseline model may be determined. The determining of operation 1105 may include obtaining the reference baseline model from a source such as a manufacturer of assets of the type subject to being modeled by process 1100. The source may be a manufacturer of the asset, a third-party servicer of the asset, an entity owner of the asset having historical data related to the asset and an understanding and knowledge of generating a baseline model of the asset, and other sources. The reference baseline model may be retrieved from a data store or memory of a database and might embody any known or future developed type of data structure. The reference baseline model obtained may be provided in numerical form or analytical form.

The reference baseline model of operation 1105 will desirably accurately represent a nominal or average behavior of the subject asset's type.

At operation 1110, a parametric model of characteristics for a specific asset is determined. The specific asset is of the same type as the type of model represented by the reference baseline model of operation 1105. The parametric model determined at operation 1110 may accurately represent the behavior of a deviation that characterizes a difference between a performance of the specific asset and the reference baseline model of operation 1105. The parametric model determined at 1110 may be a physics based model that adheres to and respects the real world, actual constraints of the specific asset (e.g., a specific aircraft having a specific tail number) for different operating conditions. For example, a physics based parametric deviation model of lift may respect the lift characteristics illustrated by FIGS. 3-6. A physics based parametric deviation model of drag may respect the drag characteristics illustrated by FIGS. 7-10.

A physics based parametric model is a significant departure from a conventional generic mathematical model such as, for example, a polynomial model or a piecewise polynomial model. A generic mathematical model such as a polynomial model can only be used to improve an overall average accuracy over the operating condition range as a whole, but not the accuracy of the model's response to specific operating parameters (e.g., Mach number) unless the physics based model happens to be a polynomial model of exactly the same form, which is generally not the case. The stability of a polynomial model is also subject to noise in the sample data.

In some aspects, the parametric model models normalized characteristics of the asset, as opposed to absolute values. In some aspects, the deviations captured by the parametric model may be focused or selectively restrained to include those that significantly impact an objective (business or otherwise) of the modeling process herein. The parameterization of the deviation model may be determined from theoretical formulas, empirical formulas, or a combination of theoretical and empirical formulas as functions of operating conditions, such as pressure, temperature, Mach number, etc., that captures the physics laws defining the behavior of the performance characteristics of the aircraft asset or a baseline model. The parametric determining process may establish the performance metric(s) to be modeled as a function of all relevant parameters that include deviation terms of their own. For example, a new formula may be derived by adding a small deviation term to each of the parameters in the original formula to reflect a performance characteristic of a specific asset. Then, the original formula is subtracted from the new formula to yield yet another new formula to represent the deviation model of a specific asset from a baseline model. Parameters in this deviation model include parameters in the original formula and deviation terms of their own. Some higher order smallness might be ignored to arrive at a simplified deviation model. Mathematical transformations and other known relationships may be used to eliminate the original parameters themselves, as they may not be known, particularly when the baseline model is given in a numerical form. Thus, the parametric model may be expressed by only the deviation terms of the original parameters. Additional mathematical transformations may be performed to obtain a deviation model in terms of derived parameters. A derived parameter may have a physics meaning of its own, for example, a vertical shift 225 of the drag polar along the vertical axis as shown in FIG. 2.

In an example of a specific aircraft asset, the performance characteristics might include, for example, drag polars as individual functions of the lift coefficient, one each at a different Mach number. In some embodiments, the performance characteristics may be transformed mathematically based on the physics law(s) relating the performance characteristics and these parameters given as discrete values to be expressed as a single analytical function, for example drag polars as a single analytical function of both the lift coefficient and Mach number.

In some aspects, the level of parameterization employed may be selectively determined to match one or more objectives of the modeling process. In some aspects, a low-level modeling might have limited accuracy, difficulties in tuning inter related model parameters, and high level of effort required in model implementation. Conversely, a high-level modeling approach might lack insights into aircraft performance characteristics, difficulties in verifying subtle details and achieving desired accuracy, convergence and stability concerns, and very small effective sample size for the same raw data pool. Some embodiments herein might use a mid-level modeling approach with parametric flight performance models and associated systems.

At operation 1115, model parameters are tuned to closely match operational data from the specific (e.g., aircraft) asset. A low-level parameterization that seeks to model a performance characteristic directly may lead to larger modeling errors because the error of the tuned model will be a fraction of the whole value of the performance characteristic. The mid-level parameterization disclosed herein will yield smaller modeling errors because the error of the tuned model will be a fraction of the per asset deviation of the performance characteristic, wherein the per asset deviation itself may typically be a small fraction of the whole value of the performance characteristic.

Continuing to operation 1120, the reference baseline model and the tuned parametric model may be combined to produce a final parametric model for the specific asset. Based on the features of the reference baseline model from operation 1105 and the parametric model of operation 1110, the final parametric performance model determined at operation 1120 may have the effect of greatly increasing the effective sample pool used in model tuning operation 1115 for a same set of raw sample data points, thereby significantly increasing a model tuning efficiency and modeling confidence. In some aspects, the parametric performance model may be characterized as simultaneously achieving high fidelity and high accuracy with respect to its representation of the modeled asset.

At operation 1125, a record of the parametric performance model determined at operation 1115 and operation 1120 may be stored in one or more formats in a data structure that can be stored as a record in a storage mechanism. The storage mechanism may be any type of tangible storage mechanism, either local, remote, or distributed and may, in some embodiments, be managed by a database, where the database might be a local database, a distributed database, and a cloud-based database including one or more nodes in any of its configurations. In some embodiments, process 1100 might be implemented on a scalable open architecture that might be extended to many different asset types and various data sources.

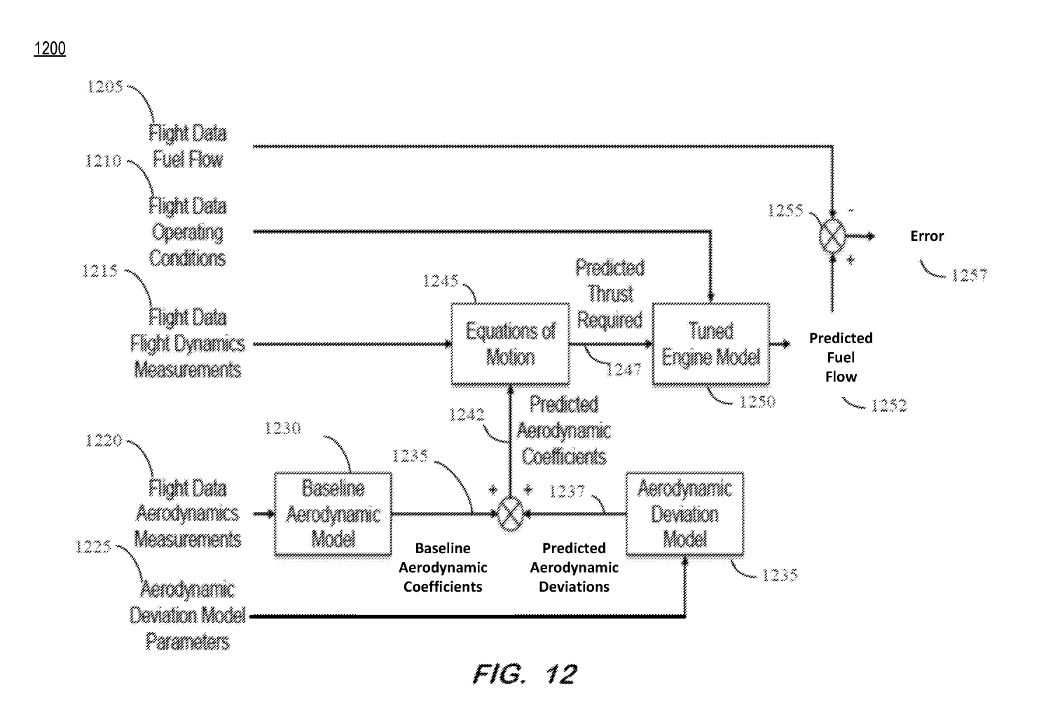

FIG. 12 is an illustrative example of a model prediction process 1200, according to some aspects herein. In some aspects, process 1200 may use tuned models from a model tuning process. The example of FIG. 12 can use tuned aerodynamic and tuned engine models to predict a flight performance such as, for example, a cruise operating cost model prediction. The data inputs used in process 1200 may be sourced from a fast-time or real-time flight simulator and a selected subset of recorded flight data measurements. The data inputs include flight data fuel flow 1205, flight data operating conditions 1210, flight data flight dynamics measurements 1215, flight data aerodynamics measurements 1220, and aerodynamics deviation model parameters 1225. In an instance a flight simulator is used, particularly if an optimization method is included in the simulator, the predicted error may indicate an accuracy of the tuned model, as well as the impact of the model's accuracy on the optimization. In the instance the model performance prediction process uses recorded flight data as shown in FIG. 12, the predicted error may indicate the accuracy of a tuned model.

Baseline aerodynamic model 1230 uses flight data aerodynamics measurements 1220 to get baseline aerodynamic coefficients 1232. The baseline aerodynamic coefficients are combined with predicted aerodynamic deviations 1237 that are calculated by the aerodynamic deviation model 1235 based on the aerodynamic deviation model parameters 1225 to obtain predicted aerodynamic coefficients 1242. In some embodiments, an aggregated aerodynamic deviation of the specific aircraft model can be obtained directly from the aerodynamic deviation model 1235 by collecting predicted aerodynamic deviations 1237 and then integrating over time (e.g., if fuel flow is the main concern), over distance (e.g., if fuel mileage is the main concern), or over any other variables as appropriate to an objective of the tuning process.

The predicted aerodynamic coefficients 1242 and the flight data flight dynamics measurements 1215 are used by the equations of motion 1245 to generate a predicted thrust required 1247. The predicted thrust is in turn used by tuned engine model 1250 to produce the predicted fuel flow at 1252. The predicted fuel flow is compared to the flight data fuel flow 1205 at 1255 to generate an error prediction 1257.

The error prediction such as that shown in FIG. 12 (or that from a simulation), may be calculated for each data point. In some aspects, aggregated model accuracy may be obtained for a large number of flights if the flights correspond to the type of use of a subject aircraft asset. Alternatively, a representative flight of a full flight profile may be used.

In some embodiments, it may be desired to maintain and track aircraft asset status changes over a period time. The status changes can be represented by changes in model parameters and further visualized by aggregated deviations. These changes might provide information for obtaining more accurate and reliable models in the future. In some regards, as the asset's configuration changes (e.g., engine replacement and engine swap), the engine parameters and engine parameter history might be part of an engine log that accompanies the engine so that changes to the engine status can be continuously tracked and maintained. A copy of the engine parameter and engine parameter history might also be kept with the airframe so that model tuning results can be compared with different engines to help maintain consistency and model stability.

It may generally be assumed that an asset's engine performance and aerodynamic performance might gradually change over time. However, if a sudden change in model parameters or aggregated deviation is observed through a model tuning process herein between time periods defined by flight cycles or flight profile segments during a same flight, then such changes might be an indication of sudden damages to the aircraft asset (e.g., airflow leaks or engine damages). In this manner, alone or in conjunction with other types of available information, one or more of the modeling and model tuning features disclosed herein might be used to detect anomalies in the operation of specific aircraft assets. In some embodiments, a tuned model may be deployed to support a number of different applications or use cases.

In some embodiments, the modeling process as shown in FIG. 11, and the prediction process as shown in FIG. 12 may be used to improve and increase the accuracy of the baseline model. If the resulting parametric performance model from operation 1120 or the predicted error 1257 shows a common bias (or a common deviation) across a fleet of assets of the same type, this may be an indication that a bias is detected in the average or nominal baseline model. The parametric model representing this common bias (or common deviation) can be added to the original baseline model to provide a new baseline model that is more accurate. Because the parametric deviation model is physics based, it reflects the deviation in the physics behavior of the asset. Thus, the process(es) provided herein may be implemented in some embodiments to reliably improve a baseline model. In particular, if a relatively low fidelity baseline model is initially available, by iteratively applying the process described herein, a very reliable and high fidelity baseline model may be obtained. With the improved baseline model, a newly tuned parametric deviation model will reflect per asset deviations without common bias(es) observed across a fleet of assets of the same type.

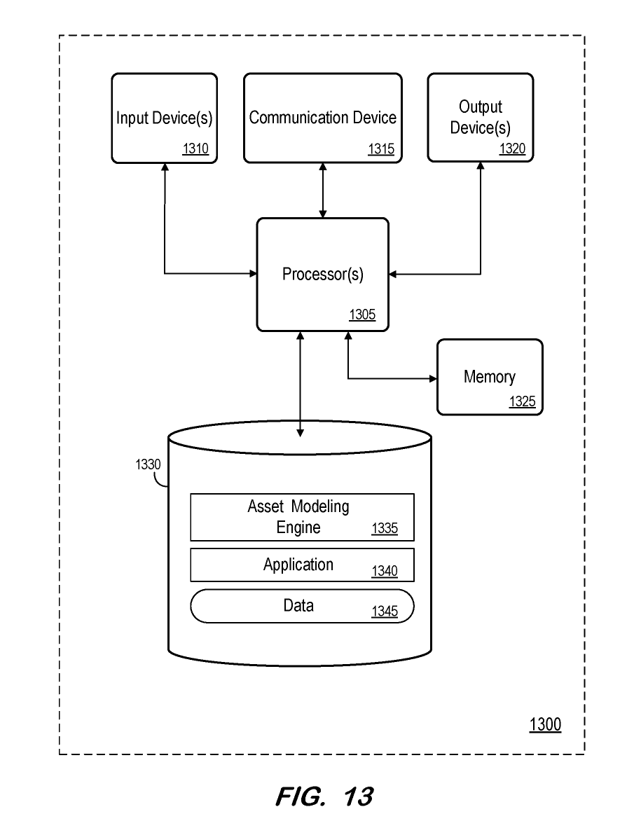

FIG. 13 is an illustrative block diagram of apparatus 1300 according to one example of some embodiments. Apparatus 1300 may comprise a computing apparatus and may execute program instructions to perform any of the functions and processed described herein (e.g., process 1100). Apparatus 1300 may comprise an implementation of server, a dedicated processor-enabled device, and other systems, including aircraft deployed systems and systems deployed in, for example, an external computational asset or facility, in some embodiments. Apparatus 1300 may include other unshown elements according to some embodiments.

Apparatus 1300 includes processor 1305 operatively coupled to communication device 1315 to communicate with other systems, data storage device 1330, one or more input devices 1310 to receive inputs from other systems and entities, one or more output devices 1320 and memory 1325. Communication device 1315 may facilitate communication with other systems and components, such as other external computational assets, an air traffic control network, and an aircraft. Input device(s) 1310 may comprise, for example, a keyboard, a keypad, a mouse or other pointing device, a microphone, knob or a switch, an infra-red (IR) port, a docking station, and/or a touch screen. Input device(s) 1310 may be used, for example, to enter information into apparatus 1300. Output device(s) 1320 may comprise, for example, a display (e.g., a display screen) a speaker, and/or a printer.

Data storage device 1330 may comprise any appropriate persistent storage device, including combinations of magnetic storage devices (e.g., magnetic tape, hard disk drives and flash memory), solid state storages device, optical storage devices, Read Only Memory (ROM) devices, Random Access Memory (RAM), Storage Class Memory (SCM) or any other fast-access memory. Data storage device 1330 might store flight data plans, optimized controls command by some embodiments herein, etc.

Asset modeling engine 1335 and application 1340 may comprise program instructions executed by processor 1305 to cause apparatus 1300 to perform any one or more of the processes described herein, including but not limited to aspects disclosed in FIG. 11. Embodiments are not limited to execution of these processes by a single apparatus.

Data 1345 (either cached or a full database) may be stored in volatile memory such as memory 1325. Data storage device 1330 may also store data and other program code for providing additional functionality and/or which are necessary for operation of apparatus 1300, such as device drivers, operating system files, etc. Data 1345 may include performance data related an aircraft that may be used in future model tuning for a specific aircraft asset for optimization purposes.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed includes:

1. A method, implemented by a processor, of developing a parametric model for a specific asset, the method comprising:
determining a reference baseline model that accurately represents a behavior of a nominal or average asset of a particular type;
determining a parametric model that accurately represents a deviation between a performance of a specific asset and the reference baseline model, the specific asset being of the particular type;
tuning the parametric deviation model using operational data from the specific asset;
combining the reference baseline model and the tuned parametric model to obtain a parametric performance model for the specific asset; and
storing a record of the parametric performance model for the specific asset.

2. The method of claim 1, wherein the baseline model is expressed in one of a numerical form, an analytical form, and a combination of numerical and analytical forms.

3. The method of claim 1, wherein the parametric model represents a deviation of at least a subset of key performance characteristics relative to the baseline model.

4. The method of claim 3, further comprising determining the at least a subset of key performance characteristics to be included in the parametric model.

5. The method of claim 1, wherein the parametric model is physics based.

6. The method of claim 5, wherein the physics based parametric model is established as a function of at least one relevant parameter having deviation terms of its own.

7. The method of claim 6, wherein the function is transformed to include the deviation terms of the at least one relevant parameter.

8. The method of claim 7, wherein at least one new derived parameter is established to represent a physical meaning of the performance deviation of the specific asset.

9. The method of claim 1, wherein the parametric model represents at least one performance metric of the specific asset at different operational conditions of the specific asset as a single function in analytical form.

10. The method of claim 1, wherein the parametric model represents at least one performance metric of the specific asset as functions in analytical form for at least one operational condition parameter given at different discrete values.

11. The method of claim 1, wherein the baseline model is improved by adding a tuned parametric deviation model reflecting a common deviation across a fleet of assets of the same type.

12. The method of claim 11, wherein the baseline model improvement is applied iteratively to obtain a reliable and high fidelity new baseline model.

13. The method of claim 1, wherein the specific asset is a specific aircraft.

14. The method of claim 13, wherein the parametric model represents a deviation of at least a subset of aerodynamic performance characteristics relative to the baseline model for the specific aircraft.

15. The method of claim 14, wherein the subset of aerodynamic performance characteristics includes at least one of Mach number corrections to lift and drag, and corrections to other factors.

16. The method of claim 1, further comprising determining, based on the record of the parametric performance model for the specific asset, a model prediction of a performance for the specific asset.

17. The method of claim 16, wherein the specific asset is a specific aircraft having at least one engine and a flight performance is predicted for the specific aircraft.

18. The method of claim 17, wherein the record of the parametric performance model for the specific asset includes a tuned aerodynamic model for the specific aircraft and a tuned engine model for each engine of the specific aircraft and the predicted flight performance is determined based on, at least, the tuned aerodynamic model and a tuned engine model.
